(19) United States
(12) Patent Application Publication
(10) Pub. No.: US 2007/0255692 A1
(43) Pub. Date: Nov. 1, 2007

(54) Research Report Search System

(76) Inventor: Ahmed Khalifa Al-Yousuf, Abu Dhabi (AE)

Correspondence Address: MICHAEL I KROLL, 171 STILLWELL LANE, SYOSSET, NY, 11791, US

(21) Appl. No.: 11/673,564

(22) Filed: Feb. 10, 2007

Related U.S. Application Data
(63) Continuation-in-part of application No. 11/412,447, filed on Apr. 27, 2006.

(51) Int. Cl. G06F 17/30

(52) U.S. Cl. 707/3

(57) ABSTRACT

The present invention relates to a searching system, and more specifically to a system for obtaining, storing, organizing and locating content in response to a user request. The system interacts with academic and professional research providers to obtain content on a variety of different topics which are stored and made available to users. The content is fully searchable and contains links to other related content.

### RELATED APPLICATIONS

This is a continuation-in-part of Ser. No. 11/412,447 filed 27 Apr. 2006.

### BACKGROUND OF THE INVENTION

1. Field of the Invention

The present invention relates to a searching system, and more specifically to a system for obtaining, storing, organizing and locating content in response to a user request. The system interacts with academic and professional research providers to obtain content on a variety of different topics which are stored and made available to users. The content is fully searchable and contains links to other related content. The searching system further provides a peer review function to the provided content whereby users can rate the relevance of the content.

2. Description of the Prior Art

Numerous other content systems exist in the prior art. However, these systems are only able to reach out and search for content based on a user entered keyword. None of the existing systems provide a centrally located and accessible storage system that is fully searchable by users thereby allowing users to obtain published material for a plurality of different uses. Therefore, a need exists to provide a system that operates to remedy the deficiencies associated with existing content systems.

### SUMMARY OF THE PRESENT INVENTION

The present invention relates to a searching system, and more specifically to a system for obtaining, storing, organizing and locating content in response to a user request. The system interacts with academic and professional research providers to obtain content on a variety of different topics which are stored and made available to users. The content is fully searchable and contains links to other related content.

A primary object of the present invention is to provide a searchable content system that overcomes the shortcomings of the prior art.

Another, secondary object of the present invention is to provide a searchable content system that interacts with content providers to obtain topic-specific content that is accessible by remote users.

Another object of the present invention is to provide a searchable content system wherein the content providers are research organizations including at least one of universities and professional research corporations and organizations.

Still another object of the present invention is to provide a searchable content system wherein the system classifies content in a plurality of academic subject areas.

Still another object of the present invention is to provide a searchable content system wherein the content is further sub-classified within each respective academic subject area.

Yet another object of the present invention is to provide a searchable content system that allows users to search the stored content to find desired content.

Still yet another object of the present invention is to provide a searchable content system that provides fee-based access to the searchable content.

Another object of the present invention is to provide a searchable content system that automatically creates fee structures to be used with different content providers based on frequency of access by users of the provided content.

Yet another object of the present invention is to provide a searchable content system wherein the content is on at least one of applied sciences, business, arts and education, health and medicine and engineering.

Yet still another object of the present invention is to provide a searchable content system wherein the content in each area is linked to related content by a relation factor.

Still another object of the present invention is to provide a searchable content system wherein the linking relation factor is at least one of topic-based, content based, author, and origin of content.

Another object of the present invention is to provide a searchable content system that allows a user to create and edit a user profile to facilitate searching of stored content.

Yet another object of the present invention is to provide a searchable content system that allows a user to rate the usefulness and/or relevance of the content providing feedback to other users.

Still yet another object of the present invention is to provide a searchable content system that is simple and easy to use.

Another object of the present invention is to provide a searchable content system that is inexpensive to manufacture and operate.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

### BRIEF DESCRIPTION OF THE DRAWING FIGURES

In order that the invention may be more fully understood, it will now be described, by way of example, with reference to the accompanying drawing in which:

FIG. 1 is an illustrative view of a screen shot for accessing a searchable content system of the present invention;

FIG. 2 is a block diagram of the searchable content system of the present invention;

FIG. 3 is a block diagram of a storage record of the searchable content system of the present invention;

FIG. 4 is a block diagram showing the organizations accessible by the searchable content system of the present invention;

FIG. 5 is a flow diagram illustrating the operation of the searchable content system of the present invention; and

FIG. 6 is a flow diagram illustrating the operation of the searchable content system of the present invention.

FIG. 7 is a flow diagram illustrating the operation of the searchable content system of the present invention with an integral peer review function.

FIG. 8 is a flow diagram illustrating the operation of the peer review function of the present invention.

### DESCRIPTION OF THE REFERENCED NUMERALS

Turning now descriptively to the drawings, in which similar reference characters denote similar elements throughout the several views, the Figures illustrate the searchable content system of the present invention. With regard to the reference numerals used, the following numbering is used throughout the various drawing Figures.

| | |
|---|---|
| 10 | searchable content system of |
| | the present invention |
| 12 | web browser |
| 14 | user access button |
| 16 | search field |
| 18 | first content category |
| 20 | first content sub-categories |
| 22 | second content category |
| 24 | second content sub-categories |
| 26 | third content category |
| 28 | third content sub-categories |
| 30 | fourth content category |
| 32 | fourth content sub-categories |
| 34 | fifth content category |
| 36 | fifth content sub-categories |
| 38 | sixth content category |
| 40 | sixth content sub-categories |
| 42 | alphabetical search function |
| 44 | access processor |
| 46 | search processor |
| 48 | storage device |
| 49 | payment processor |
| 50 | organization processor |
| 51 | display generator |
| 52 | input processor |
| 54 | first classification field |
| 56 | second classification field |
| 58 | third classification field |
| 60 | fourth classification field |
| 62 | fifth classification field |
| 64 | sixth classification field |
| 66 | first content provider |
| 68 | second content provider |
| 70 | third content provider |
| 72 | fourth content provider |
| 74 | fifth content provider |

### DETAILED DESCRIPTION OF THE PREFERRED EMBODIMENT

The following discussion describes in detail one embodiment of the invention. This discussion should not be construed, however, as limiting the invention to those particular embodiments. Practitioners skilled in the art will recognize numerous other embodiments as well. For definition of the complete scope of the invention, the reader is directed to appended claims.

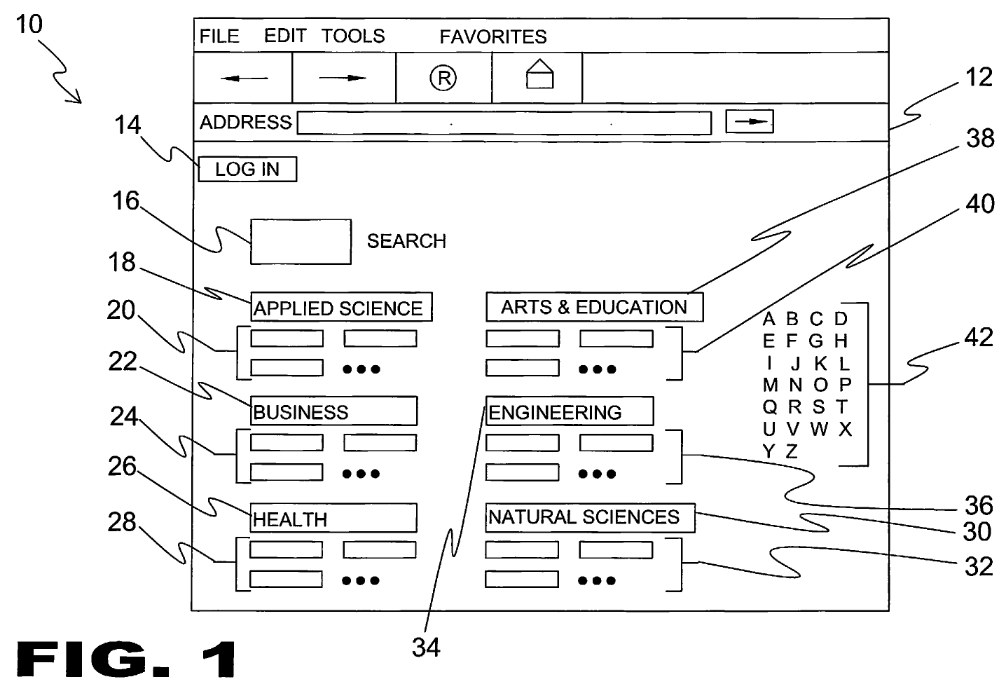

Turning now descriptively to the drawings, in which similar reference characters denote similar elements throughout the several views, FIGS. 1 through 6 illustrate a searchable content system of the present invention which is indicated generally by the reference numeral 10.

The searchable content system 10 provides research-based content creators and distributors to have the created content organized and accessed for commercial gain. The system seeks out the research-based content providers and acquires the content for use by users of the system. Access to the content system 10 is made via a communication network such as the Internet. However, any communication network that allows for remote users to access a central system may be employed. The system 10 allows the content providers to offer for sale the published research results. Users of the system are able to obtain the research results via a plurality of different economic models such as subscription-based service whereby the user pays a predetermined fee to access the content or a pay-per-use system whereby the user pays for each individual content piece viewed and/or downloaded.

FIG. 1 is an illustrative view of a screen shot for accessing the searchable content system 10 of the present invention. Typically, the system 10 is operated on a central sever or computer system that is simultaneously remotely accessible via a communication network by a plurality of users. The screenshot depicted in FIG. 1 is an exemplary display made to a remote user accessing the system 10. The system 10 is accessed by entry of the website address into a web browser 12. The web browser 12 displays a home page that includes a visual representation of data stored, organized and accessible by the system 10. The browser window 12 displays a plurality of different ways that a user may access the content of the system 10. The content is fully searchable and the browser provides different mechanisms to accomplish this search.

A free form search can be performed by entry of a text string in a search field box 16. Alternatively, a search can be performed by selection of one of a plurality content category buttons including but not limited to a first content category button 18, a second content category button 22, a third content category button 26, a fourth content category button 30, a fifth content category button 34 and a sixth content category button 38. The content categories that may be represented by these buttons, 18, 22, 26, 30, 34 and 38 may be applied science, business, health, natural sciences, engineering, and arts and education respectively. However, this is for purposes of example only and the content category buttons 18, 22, 26, 30, 34 and 38 may represent other content categories.

A more focused search can be performed by selection of one of a plurality of sub-category buttons corresponding to the content category buttons. A first content sub-category button 20 corresponds to the first content category button 18 and may represent a sub-category including but not limited to agriculture, astronomy and chemistry. A second content sub-category button 24 corresponds to the second content category button 22 and may represent a sub-category including but not limited to accounting, finance and management. A third content sub-category button 28 corresponds to the third content category button 26 and may represent a sub-category including but not limited to dental, pediatrics and pharmacy. A fourth content sub-category button 32 corresponds to the fourth content category button 30 and may represent a sub-category including but not limited to economics, philosophy and sociology. A fifth content sub-category button 36 corresponds to the fifth content category button 34 and may represent a sub-category including but not limited to energy, mechanical and electrical. A sixth content sub-category button 40 corresponds to the sixth content category button 38 and may represent a sub-category including but not limited to languages, literatures and music.

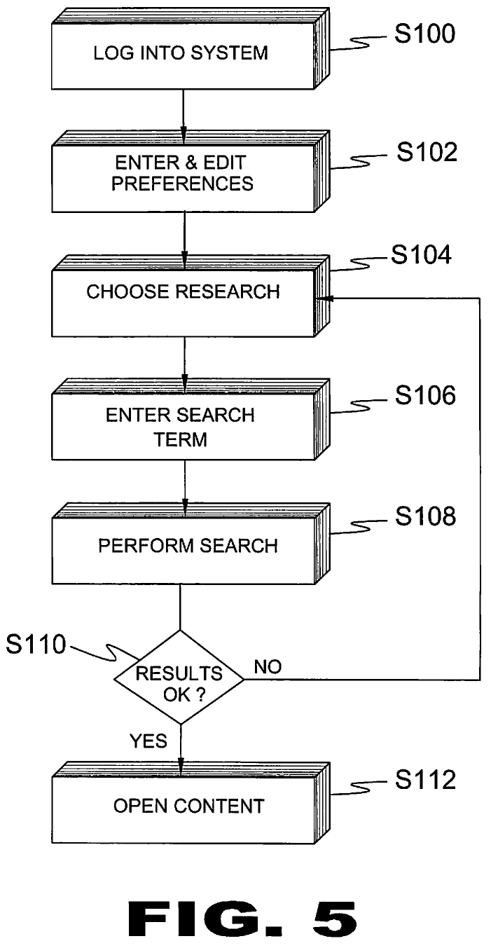

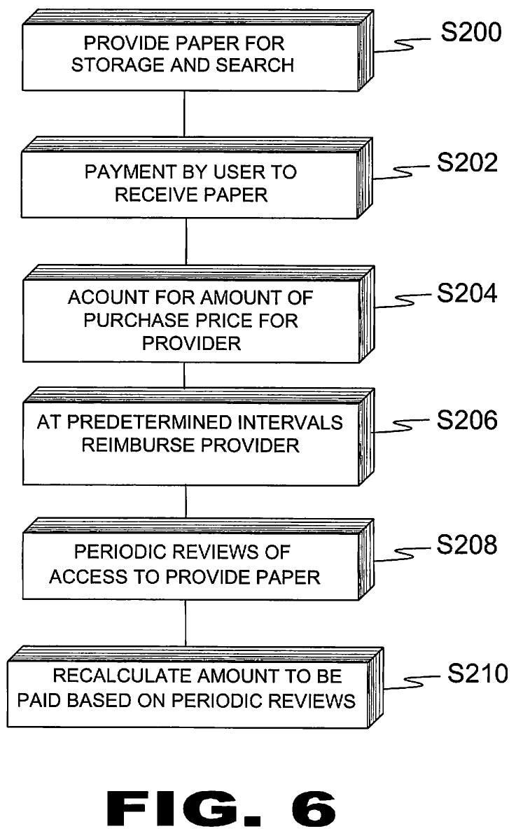

Alternatively, a search can be performed using an alphabetical search function 42. The alphabetical search function 42 lists the letters of the alphabet enabling the selection of the first letter of the content category to be searched. After the search is performed, a plurality of papers is provided, as discussed hereinafter with specific reference to FIGS. 5 and 6.

Selection of a “log in” button 14 enables a user who has set up an account to access the system. Alternatively, the user can search for content before depressing the “log in” button 14. However, the access provided to the user who does not log in via log-in button 14 is limited. For example only a summary of the content may be made available on a further provided webpage which would also provide the user with options on how to obtain full access the selected content.

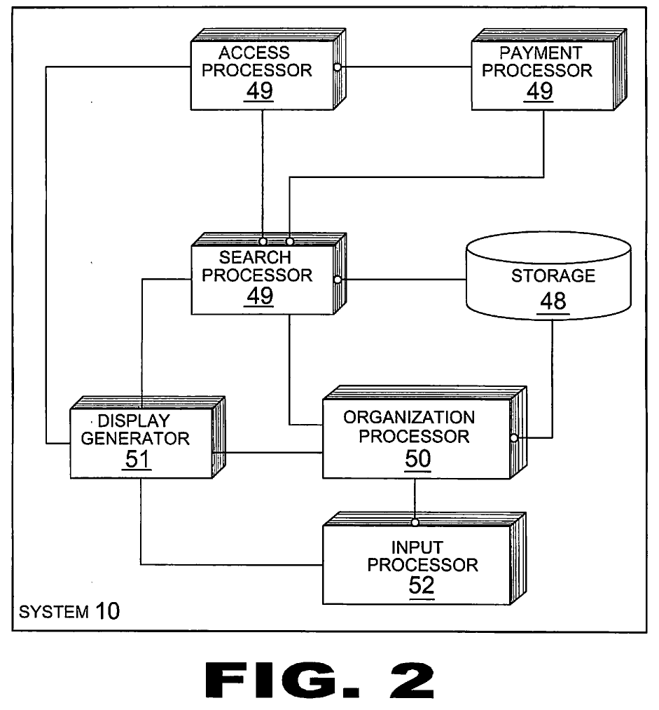

FIG. 2 is a block diagram of the searchable content system 10 of the present invention. Shown herein, the system 10 includes an input processor 52 for at least one of receiving and actively acquiring content from content sources. The input processor 52 connects, via a communication network (not shown) to at least one content provider. The input processor 52 may use an algorithm based on a pre-existing relationship with the at least one content provider in order to acquire content for the system 10. Additionally, content providers not having a relationship with the system 10 may access the system 10 via the input processor 52 in order to at least one of establish a relationship and provide content able to be accessed by a user of the system.

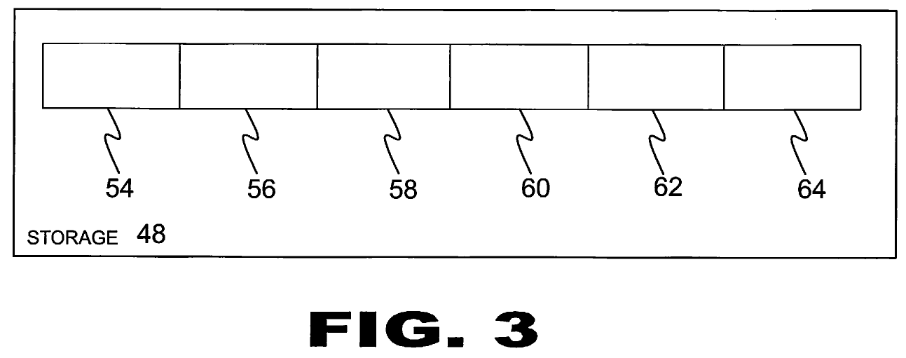

The system 10 includes an organization processor 50 and a storage medium 48. The organization processor 50 is connected to each of the storage medium 48 and the input processor 52. The organization processor 50 uses a plurality of algorithms to organize the content that is acquired and/or received by the input processor 52. The algorithms employed by the organization processor 50 parses and analyzes the acquired content and adds a plurality of classification tags, which will be discussed hereinafter with respect to FIG. 3, to be associated with each respective content item obtained via the input processor 52. Upon organizing the content, the organization processor 50 causes data representing the content to be stored within the storage medium 48. Alternatively, the storage medium 48 may be a pre-programmed database that, upon access by the organization processor 50, provides information thereto to be used to organize the acquired content. In this embodiment, the organization processor 50 parses the content for flags that correspond to the fields of the database 48.

The system further includes an access processor 44, a payment processor 49 and a search processor 46 each connected to one another. The search processor 46 is further connected to the storage medium 48 and the organization processor 50. Users of the system 10 attempting to gain access to the content stored on the storage medium 48 connect via the access processor 44. The access processor 44 determines, in response to use input, the type of access that each respective connecting user will have to the content stored in the storage medium 48. The access processor 44 determines if the user has at least one of full or partial access to the content in the storage medium 48. The access processor 44, in response a determination of partial access, signals the payment processor 49 to request payment from the connecting user for a higher level of access to the system 10.

In response to the determination made by the access processor 44, the user may search the storage medium for content using the storage processor 46. Prior to the search, the search processor 46 detects from at least one of the organization processor 50 and the storage medium 48 parameters used to organize the stored content. The detection performed by the search processor 46 includes obtaining data representing the classification fields that are used to organize and store the content. The user is then able to perform a search by inputting a search criteria. The search criteria includes at least one of inputting a search term, selecting from a plurality of search terms and selecting an alphanumeric character for use by the search processor 46. The search processor 46 compares and analyzes the search criteria with the classification data to select content from the storage medium 48 to be presented to the user.

Upon presenting the searched content to the user, and a prior determination that the user has full access to the system 10, the content may be available to be at least one read, viewed, printed and downloaded by the user. The retrieved content is fully available to the user. If the determination by the access processor 46 results in a partial access determination, only a summary of the retrieved content is made available to the user. The payment processor 49 causes a message to be displayed to the user requesting payment to obtain full access to the content. The user may input payment information in the form of a credit card and an online payment system such as PAYPAL. Payment methods provided by the payment processor 49 may allow for at least one of access to a single stored item, access to a predetermined number of stored items, full service subscription to the system 10.

Additionally, the payment processor 49 is able to remit payments to content providers based on a contract rate established between the system 10 and the respective content provider. Specifically, upon selection of a desired item, the search processor 46 may store, in the storage medium, a log representing the number of times each specific item is at least one of returned in search and selected by a user. The payment processor 49 may actively and automatically adjust a term of the contract between the provider and the system 10 based on threshold access values that are included within the contract. The payment processor 49 automatically remits payment according to the terms of the modified contract. This active and automatic modification provides incentives to the content providers to provide highly useable and desirable content to the system 10.

A display generator 51 is connected to each of the access processor 44, the payment processor 49 via the access processor 44, the search processor 46, the organization processor 50 and the input processor 52. The display generator 51 receives instructions in the form of machine executable code that generates a display for display to a user that allows the user to perform and access the system 10 in the manner discussed above.

FIG. 3 is a block diagram of the storage device 48 of the searchable content system 10 of the present invention. The storage device 48 may include a plurality of classification fields. These fields are represented herein as a first classification field 54, a second classification field 56, a third classification field 58, a fourth classification field 60, a fifth classification field 62 and a sixth classification field 64. The classification fields 54, 56, 58, 60, 62 and 64 may correspond to the content categories, 18, 22, 26, 30, 34, 36 and 38, respectively, and represent how the papers are stored and classified in the storage device 48. Alternatively, the classification fields may represent different identification items that may be associated with the respective content. The identification items include at least one of author, subject matter, type of content, date of content creation, author provided keywords, related subject matter and related content by same author. This list of identification items is provided for purposes of example only and the classification fields 54, 56, 58, 60, 62, 64 may include any information selected by at least one of a system operator and content provider to identify the content. The number of classification fields 54, 56, 58, 60, 62, 64 are further provided for exemplary purpose and may include any number of fields to further enhance the classification of the acquired content. These classification fields are used by the search processor 46 for comparison with the user entered search criteria in order to return content that best matches the user request.

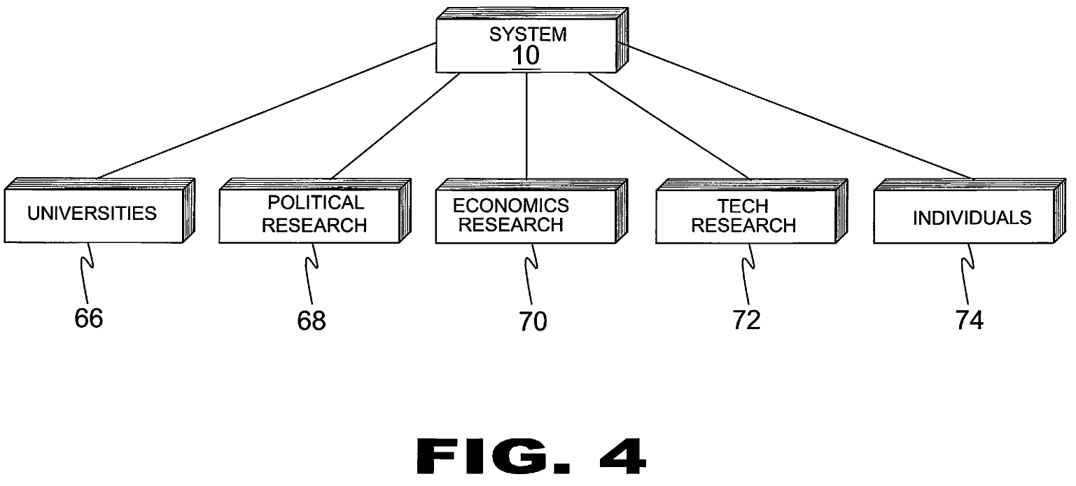

FIG. 4 is a block diagram showing the organizations accessible by the searchable content system 10 of the present invention. The system 10 can selectively contract with and receive content from a plurality of content providers, including but not limited to a first content provider 66, a second content provider 68, a third content provider 70, a fourth content provider 72 and a fifth content provider 74. A plurality of content providers may be represented and herein they are represented by universities as the first content provider 66, political research as the second content provider 68, economics research as the third content provider 70, technology research as the fourth content provider 72 and individuals as the fifth content provider 74. Varied providers enable the system 10 to include the most up-to-date and world wide research in the particular content area.

FIG. 5 is a flow diagram illustrating the operation of the searchable content system 10 of the present invention. In step S100, the user logs into the system by selection of the “log-in” button 14 shown in FIG. 1. The user may enter and edit their preferences in step S102. In step S104, the user chooses the type of content area to search, such as by use of the plurality of content category buttons 18, 22, 26, 30, 34 and 38, shown in FIG. 1. In step S106, the user is then able to further focus the search within the category by entry of a search term in the search field 16, shown in FIG. 1. A search is then performed in step S108. The results of the search are output in step S110. If the results are insufficient, the user is returned to step S104 to repeat the process. If the results displayed in step S110 are sufficient, the appropriate paper is displayed in step S112.

FIG. 6 is a flow diagram illustrating the operation of the searchable content system 10 of the present invention. In step S200, a paper is provided for storage in the storage device 48, shown in FIG. 2, to be searched for at a later time. In step S202, a user makes a payment to receive the paper. The amount of the purchase price for the provider is accounted for in step S204. The provider is reimbursed at predetermined intervals in step S206 for the purchase of their papers from the system 10. In step S208, the access to provide the paper is periodically reviewed. In step S210, the amount to be paid to the provider is recalculated based on the periodic reviews.

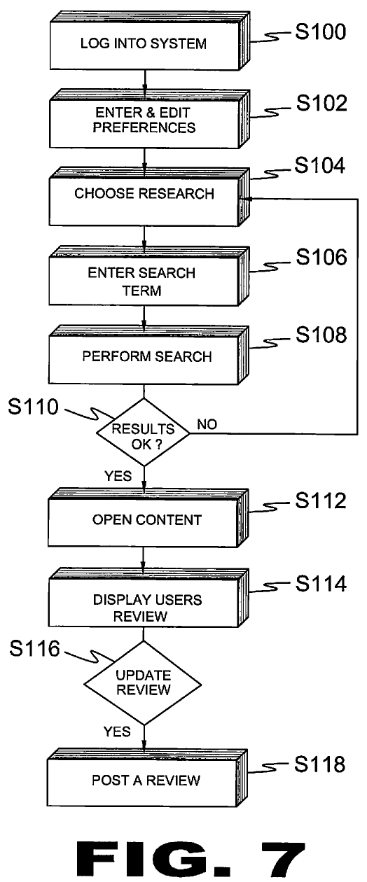

FIG. 7 is a flow diagram illustrating the operation of the searchable content system 10 of the present invention with an integral peer review function. In step S100, the user logs into the system by selection of the “log-in” button 14 shown in FIG. 1. The user may enter and edit their preferences in step S102. In step S104, the user chooses the type of content area to search, such as by use of the plurality of content category buttons 18, 22, 26, 30, 34 and 38, shown in FIG. 1. In step S106, the user is then able to further focus the search within the category by entry of a search term in the search field 16, shown in FIG. 1. A search is then performed in step S1108. The results of the search are output in step S110. If the results are insufficient, the user is returned to step S104 to repeat the process. If the results displayed in step S110 are sufficient, the appropriate paper is displayed in step S112 with the peer review displayed in step S114. In step S116 the user is provided the option of placing a review as to the value and relevance of the content that when exercised allows the user to post a review in step S118.

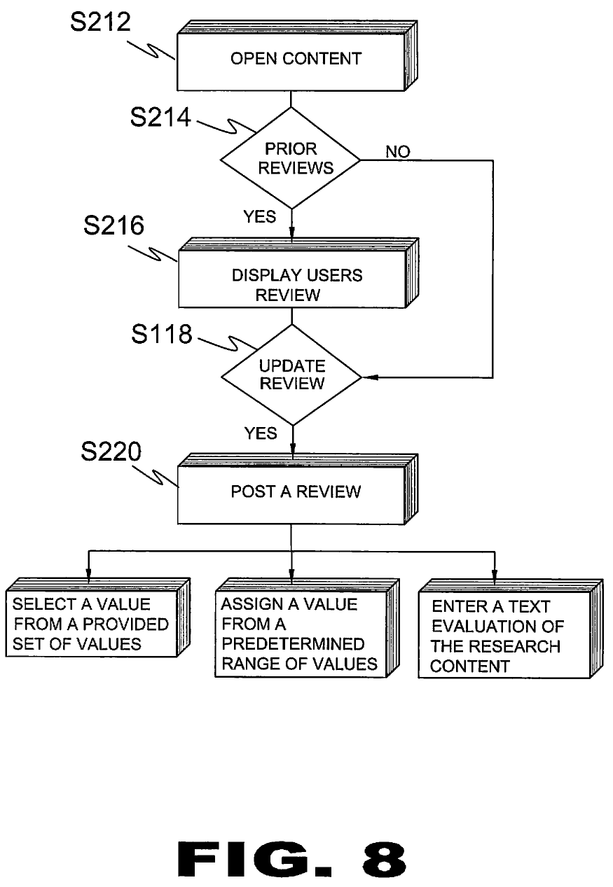

FIG. 8 is a flow diagram illustrating the operation of the peer review function of the present invention. In step S212 the research content is displayed and if a user review is available, in step S214, it too is displayed, as shown in step S216. The user can choose to add a review of the content, in step S216. In step S220, the user can add a review as to the value and relevance of the content. The peer review can take the form of selecting a value from a provided number of values or assign a value from a predetermined range of values or enter a text evaluation of the research content.

It will be understood that each of the elements described above, or two or more together may also find a useful application in other types of devices differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A system for storing and retrieving data representing research materials comprising:
a. a repository for storing said data representing research materials obtained from a plurality of remote sources;
b. a processor connected to said repository for organizing said stored data and for retrieving said data;
c. a user interface including means for receiving at least one input from a user defining a search criteria, wherein upon receiving said input said processor retrieves stored data representing a desired research material based on said search criteria for output to said user.

2. The system as recited in claim 1, further comprising a display generator for displaying to a user said output representing said desired research material.

3. The system as recited in claim 1, further comprising a display generator for receiving machine executable code for creating said user interface means.

4. The system as recited in claim 1, further comprising means for providing output to a user.

5. The system as recited in claim 4, wherein said output providing means is at least one of said user interface and a transmission device for transmitting said output to a user via an e-mail address.

6. The system as recited in claim 1 wherein said user, via said user interface, at least one of selects a predefined search indicator, enters a free-form text string and selects a letter corresponding to the first letter of a search term.

7. The system as recited in claim 6, further comprising a plurality of predefined sub-search indicators that correspond to each predefined search indicator.

8. The system as recited in claim 1, further comprising an access processor for selectively determining an access level associated with a user requesting access to said system, wherein said determination results in said user having at least one full access to system content and partial access to system content.

9. The system as recited in claim 8, further comprising a payment processor for requesting payment for access to said system.

10. The system as recited in claim 9, wherein in response to a determination by said access processor of partial access, said payment processor generates a payment request to be provided to said user.

11. The system as recited in claim 9, wherein said processor is a search processor for searching content stored in said repository.

12. The system as recited in claim 11, wherein in response a determination by said access processor of partial access and a search by said search processor, said user interface generator provides a summary of said research material and said payment processor generates a payment request message to be provided to said user requesting payment for full access to said research material.

13. The system as recited in claim 9, wherein said payment processor records submission of a payment from said user for receipt of said output representing said desired research material.

14. The system as recited in claim 9, wherein said processor stored contract terms between governing payment to said content providers for said content.

15. The system as recited in claim 14, wherein said payment processor automatically remits payment according to said contract terms to each remote source content provider at predetermined intervals.

16. The system as recited in claim 14, wherein said payment processor actively reviews access to said output representing said desired research material by said user at predetermined intervals and logs information corresponding to said review.

17. The system as recited in claim 16 wherein said payment processor automatically modifies said contract terms in response to said review meeting a threshold value and determines a modified fee to remit to said remote source providing said data representing research materials based on user initial access and additional access to said output representing said desired research material.

18. The system as recited in claim 6, wherein said predefined search indicators represent content areas including at least one of applied sciences, business, health, natural sciences, engineering and arts and education.

19. The system as recited in claim 1 whereby the output representing said desired research material is saved to a file.

20. The system as recited in claim 1 wherein said remote sources include at least one of universities, political research, economic research, technical research and individuals.

21. The system as recited in claim 1, further comprising a peer review function wherein user can rate the research material.

22. The system as recited in claim 21, wherein the peer review is displayed along with the retrieved content.

23. The system as recited in claim 22, wherein the user can post a review of the relevance and value of the retrieved research content.

24. The system as recited in claim 23, wherein the user's review is saved to a file for retrieval and display for other users of the research material.

25. The system as recited in claim 24, wherein the user review function includes selecting a value from a provided set of values, assigning a value between a predetermined range of values and entering a text evaluation as to the value and relevance of the research content.
